(19) United States
(12) Patent Application Publication
(10) Pub. No.: US 2014/0130096 A1
(43) Pub. Date: May 8, 2014

(54) SYSTEM AND METHOD FOR ORGANIZING AND DISPLAYING A LIST OF TELEVISION PROGRAMS

(71) Applicant: KISHORE ADEKHANDI KRISHNAMURTHY, BANGALORE (IN)

(72) Inventor: KISHORE ADEKHANDI KRISHNAMURTHY, BANGALORE (IN)

(21) Appl. No.: 14/059,223

(22) Filed: Oct. 21, 2013

(30) Foreign Application Priority Data
Nov. 7, 2012 (IN) 4683/CHE/2012

(51) Int. Cl. H04N 21/482

(52) U.S. Cl. CPC H04N 21/482
USPC 725/46

(57) ABSTRACT

A method for organizing a plurality of television programs is provided. The method includes (i) obtaining a first personalized list of television programs that are scheduled for broadcast at a current time, (ii) obtaining a second personalized list of television programs that includes television programs that are scheduled to be broadcast at a subsequent duration, (iii) displaying, at a display unit, the first personalized list of television programs that are scheduled for broadcast at the current time as a one dimensional set, and (iv) displaying, at the display unit, the second personalized list of television programs that are scheduled to be broadcast at the subsequent duration as a one dimensional set. The first personalized list of television programs and the second personalized list of television programs are personalized separately based on at least one parameter other than a channel associated with the television programs.

### CROSS-REFERENCE TO RELATED APPLICATIONS

This application claims priority to Indian patent application no. 4683/CHE/2012 filed on Nov. 7, 2012, the complete disclosure of which, in its entirely, is herein incorporated by reference.

### BACKGROUND

1. Technical Field

The embodiments herein generally relate to organizing time scheduled television content, and, more particularly, to a system and method for organizing and displaying a list of television programs.

2. Description of the Related Art

Cable, satellite, and broadcast television systems provide viewers with a large number of television channels. Users traditionally consult printed television program schedules to determine which programs are being broadcast at what times. Cable, satellite, and broadcast television systems provide viewers with a large number of television channels. Linear television is a television service where the viewer has to watch a scheduled television program at the particular time it is offered, and on the particular channel it is presented on. In linear television, when a user switches a television on, the user may not be sure of what to watch, and may keep on flipping the channels to find a show that may be of his/her interest. Also, sometimes, the user may not actually end up watching a show of his/her interest, simply because he/she is not aware of which channel or show is being aired at that time.

An electronic program guide (EPG) provides users of television, radio, and other media applications with continuously updated menus displaying broadcast programming or scheduling information for current and upcoming programming. EPG data is typically presented in a grid. The EPG data presented in the grid is typically static and non-interactive. The EPG data represents the channels along the y-axis and time along the x-axis. It may be organized according to various categories (e.g., movies, sports, entertainment etc.). Typically, a user may browse a category vertically to select a channel and the current program being shown on the channel, and simultaneously navigate the channel horizontally to find other programs at future times.

Hence, in order to plan for future viewing, the user would only be able to navigate one channel at a time. Further, even if the grid allows a user to view shows across channels at different times, the user would still have to navigate the EPG to get only partial information for those channels and times on a given screen. This limited information would make it difficult for the user to plan and schedule his television viewing effectively. Accordingly there is a need for a system and method to organize and display a linear television program guide so as to facilitate discovery of television programs that are of interest which are scheduled at different times and for better planning of future viewing.

### SUMMARY

In view of the foregoing, an embodiment herein provides a method for organizing a plurality of television programs. The method includes (i) obtaining a first personalized list of television programs that are scheduled for broadcast at a current time, (ii) obtaining a second personalized list of television programs that comprises television programs that are scheduled to be broadcast at a subsequent duration, (iii) displaying, at a display unit, the first personalized list of television programs that are scheduled for broadcast at the current time as a one dimensional set, and (iv) displaying, at the display unit, the second personalized list of television programs that are scheduled to be broadcast at the subsequent duration as a one dimensional set. The first personalized list of television programs and the second personalized list of television programs may be personalized separately based on at least one parameter other than a channel associated with the television programs. The method may further include dynamically updating the first personalized list of television programs and the second personalized list of television programs to be displayed based on (i) the current time, and (ii) a set of parameters. A first combination of channels and a second combination of channels is selected and ordered based on the set of parameters which are targeted to a user.

The first combination of channels and the second combination of channels may be different. The method may further include processing, by a processor, filtering the plurality of television program to obtain a list of filtered television programs based on the set of parameters. The set of parameters may include at least one of a) interests or habits associated with a user, b) preferences of the user from a viewing pattern of the user, (c) activities of at least one user connected to the user on a social medium, (d) online viewing habits of the user, and (e) popularity ratings.

The list of filtered television programs may be organized to obtain at least one of (a) the first personalized list of television programs that are scheduled for broadcast across the first combination of channels at the current time, and (b) the second personalized list of television programs that are scheduled to be broadcast across the second combination of channels in the subsequent duration based on broadcast information. The broadcast information may include a broadcast time associated with the list of filtered television programs. The subsequent duration may be a remaining part of a same day as the current time. The subsequent duration may ranges from a next day to a remaining part of a same week as the current time. The subsequent duration may be a range of time slots associated with television program schedule in a one dimensional set.

The method may further include processing, by the processor, a first input comprising at least one of (a) a selection of a television program from the first personalized list of television programs, or (b) a selection of a television program from the second personalized list of television programs. The first personalized list of television programs may include a plurality of subset of programs. The method may further include processing, by the processor, (a) displaying, at the display unit, content associated with the television program that is selected from the first personalized list of television programs, or (b) generating at least one of (i) a watch list, and (ii) a favorites list that include the television program which is selected from the second personalized list of television programs.

The method may further include (a) computing a similarity between a watch list of a first user and a watch list of a second user, and (b) recommending (i) a first list of non-overlapping television program to the first user based on the watch list of the second user and the similarity, and (ii) a second list of non-overlapping television program to the second user based on the watch list of the first user and the similarity. The method may further include processing, by the processor, a second input comprising an indication to navigate from a first subset of television programs to a second subset of television programs. The first subset of television programs and the second subset of television programs may be selected from at least one of (a) the first personalized list of television programs, and (b) the second personalized list of television programs.

In another aspect, a system for organizing television programs is provided. The system includes a processor, and a memory storing instructions to configure the processor. The processor is configured by the instructions to (a) obtain a plurality of television programs, (b) filter the plurality of television programs to obtain a list of filtered television programs based on a set of parameters, (c) obtain broadcast information associated with the list of filtered television programs from an electronic program guide server, (d) organize the list of filtered television programs to obtain a list of organized television programs based on the broadcast information, and (d) communicate the list of organized television programs to a display module, executed by the processor, to display at the display unit, (i) the first personalized list of television programs that are scheduled for broadcast across the first combination of channels at the current time, and (i) the second personalized list of television programs that are scheduled to be broadcast across the second combination of channels in the subsequent duration. The list of organized television programs may include at least one of (i) a first personalized list of television programs that are scheduled for broadcast across a first combination of channels at a current time, and (i) a second personalized list of television programs that are scheduled to be broadcast across a second combination of channels in a subsequent duration.

The first combination of channels and the second combination of channels may be different. The first combination of channels and the second combination of channels may be selected and ordered based on a set of parameters which are targeted to a user. The broadcast information may include a broadcast time associated with the television program. The subsequent duration may be a remaining part of a same day as the current time. The subsequent duration may ranges from a next day to a remaining part of a same week as the current time. The subsequent duration may be a range of time slots associated with television program schedule in a one dimensional set. The processor may be further configured to process a first input comprising at least one of (i) a selection of a television program from the first personalized list of television programs, or (ii) a selection of a television program from the second personalized list of television programs. The first personalized list of television programs may include a plurality of subset of programs. The processor may be further configured to (a) display, at the display unit, content associated with the television program that is selected from the first personalized list of television programs, or (b) generate at least one of (i) a watch list, and (ii) a favorites list that comprises the television program which is selected from the second personalized list of television programs.

The system may further include a navigation module, executed by the processor, that process a second input include an indication to navigate from a first subset of television programs to a second subset of television programs. The first subset of television programs and the second subset of television programs may be selected from (a) the first personalized list of television programs, and (b) the second personalized list of television programs. The set of parameters may include at least one of a) interests or habits associated with a user, b) preferences of the user from a viewing pattern of the user, (c) activities of at least one user connected to the user on a social medium, (d) online viewing habits of the user, and (e) popularity ratings.

In yet another aspect, a program organizing server for organizing television programs that is targeted to a user is provided. The program organizing server includes a processor and a memory storing instructions to configure the processor. The processor is configured by the instructions to (i) obtain television program schedules for one or more channels, (ii) personalize, independent of channel, at least a subset of the television programs that are scheduled at a current time to obtain a first personalized list of television programs, (iii) personalize, independent of channel, at least a subset of the television programs that include television programs that are scheduled at a subsequent duration to obtain a second personalized list of television programs, (iv) display, at a display unit or communicate to a display unit, the first set of personalized television programs in a one dimensional format of personalized television programs, and (v) display, at a display unit, or communicate to a display unit the second set of personalized television programs in a one dimensional format of personalized television programs. The schedules may include television programs that correspond to different time slots for each of the one or more channels.

In further aspect, a method for organizing a plurality of television program is provided. The method includes (i) obtaining at least one of (a) a first personalized list of television programs, and (b) a second list of personalized television programs; and (ii) displaying, at a display unit, (a) the first personalized list of television programs that are scheduled for broadcast across a first combination of channels at a current time, and (b) the second personalized list of television programs that are scheduled to be broadcast across a second combination of channels in a subsequent duration. The first combination of channels and the second combination of channels may be different. The first combination of channels and the second combination of channels may be selected and ordered based on a set of parameters which are targeted to a user.

### BRIEF DESCRIPTION OF THE DRAWINGS

The embodiments herein will be better understood from the following detailed description with reference to the drawings, in which:

FIG. 1 illustrates a system view of an Electronic program guide (EPG) server communicating with a program organizing system for organizing a list of television programs that are being broadcasted according to an embodiment herein;

FIG. 2 illustrates an exploded view of the program organizing system of FIG. 1 according to an embodiment herein;

FIG. 3A illustrates an user interface view of how the list of television programs is organized and displayed according to an embodiment herein;

FIG. 3B illustrates an user interface view of organizing and displaying a list of television programs that are currently broadcasted according to an embodiment herein;

FIG. 3C illustrates an user interface view of organizing and displaying the list of television programs scheduled to be broadcast at a subsequent duration according to an embodiment herein;

FIG. 3D illustrates a user interface view of organizing and displaying the list of television programs scheduled to be broadcast at a subsequent duration according to an embodiment herein;

FIG. 4 is a flow diagram illustrating a method of organizing and displaying a list of television programs that are targeted to the user according to an embodiment herein;

FIG. 5 illustrates an exploded view of a computing device 114 of FIG. 1 according to the embodiments herein; and

FIG. 6 illustrates a schematic diagram of a computer architecture used in accordance with the embodiments herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

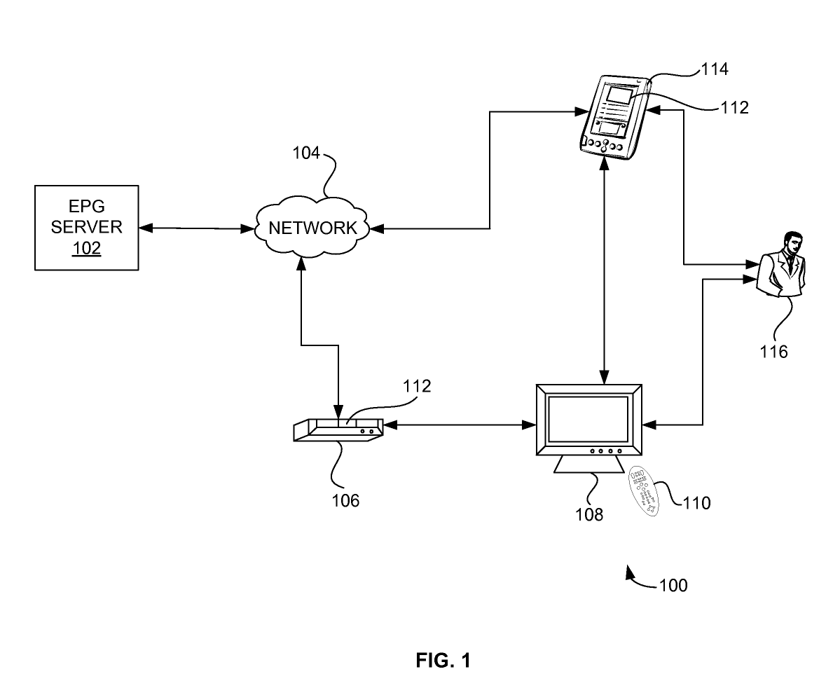

As mentioned, there remains a need for a system to organize and display a linear television program guide so as to better facilitate discovery of television programs that are of interest scheduled at different times and to facilitate better planning of future viewing. The embodiments herein achieve this by providing a program organizing system that organizes a first set of personalized television programs that are scheduled at a current time, and a second set of personalized television programs that are scheduled at a subsequent duration and presents in a one dimensional format so as to enable a user to simultaneously visualize content. Referring now to the drawings, and more particularly to FIG. 1 through 6, where similar reference characters denote corresponding features consistently throughout the figures, preferred embodiments are described herein.

FIG. 1 illustrates a system view 100 of an Electronic program guide (EPG) server 102 communicating with a program organizing system 112 for organizing a list of television programs that are being broadcasted according to an embodiment herein. The system view 100 includes an EPG server 102, a set-top box 106, a display device 108, a display control device 110, a program organizing system 112, a computing device 114, and a user 116. The EPG server 102 includes the information about the list of television programs and broadcast time that are obtained from different sources (e.g., an Electronic program guide, an online program guide etc.). The programs are broadcasted on the display device 108 (e.g. a Television) through a network 104 via the set-top box 106. In one embodiment, the network 104 may be the internet, or a broadcast network. In one embodiment, the list of television programs to be broadcasted may be made accessible in an online program service portal. In one embodiment, the set-top box 106 may communicate with the EPG server 102 through a broadcast network. The display control device 110 is used by the user 116 to control the display device 108. In one embodiment, the display control device 110 may be a remote control device (e.g. a television remote). The information relating to the list of television programs is communicated to the program organizing system 112, which may be implemented in the computing device 114, the set-top box 106, and/or the display device 108. For example, the computing device 114 is a mobile phone, a smart phone, a tablet PC, a laptop, a desktop, and an ultra book etc.

In one embodiment, the user 116 may view the list of television programs which are organized into a first personalized list of television programs that are scheduled for broadcast at the current time as a one dimensional set (e.g., now), and a second personalized list of television programs that are scheduled to be broadcast at a subsequent duration as a one dimensional set (e.g., next which include a list of television programs to be aired next during the same day, and later which includes a list of television programs to be aired in later the same week, or forthcoming weeks) in the computing device 114. In one embodiment, the subsequent duration may be a remaining part of a same day as the current time. For example, the subsequent duration ranges from a next day to a remaining part of a same week as the current time. In another example, the subsequent duration a range of time slots associated with television program schedule in a one dimensional set. In one embodiment, the television program schedule is obtained from a different source. Based on a list of organized television programs, the user 116 may schedule programs that he/she wants to watch for the entire week.

For example, a list of organized television programs that are scheduled to be aired later this week may include a movie “Forrest Gump”, a television series “Firefly” and an episode of “Sherlock homes”. The user 116 selects “Forrest Gump” as their interest to watch later this week. In one embodiment, the EPG server 102 may communicate an information associated with the user 116 (e.g. user interest and user preferences) to a remote server so that the program organizing system 112 may dynamically organize the list of television programs which are to be aired now, next and later this week. In one embodiment, the program organizing system 112 organizes the list of television programs based on time bound live electronic program guide (EPG) data obtained from the electronic program guide (EPG) server 102.

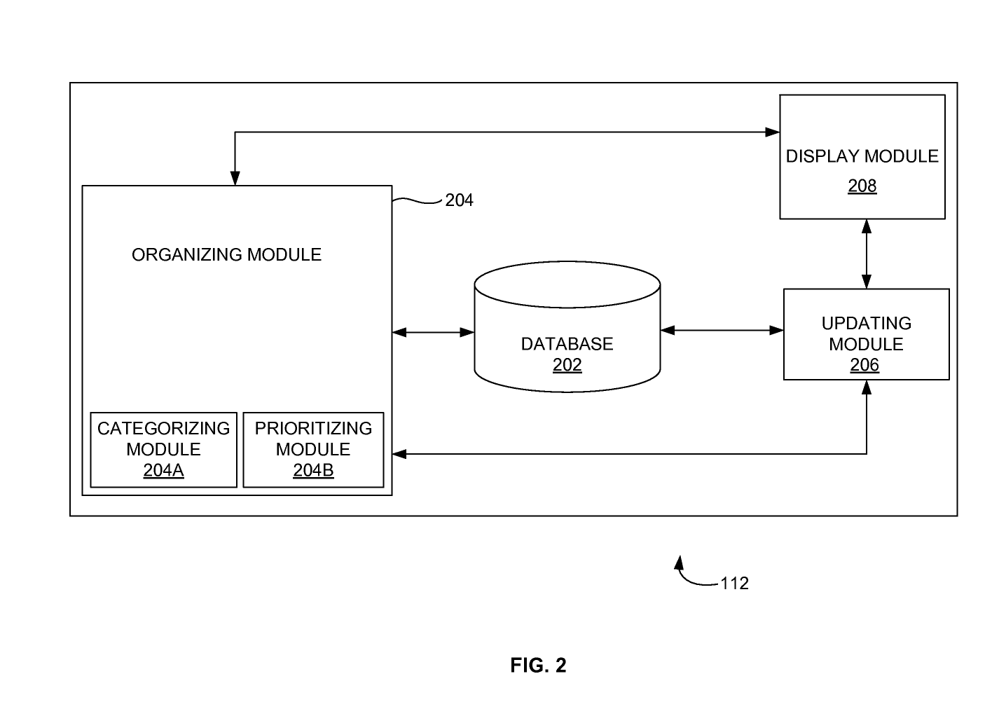

FIG. 2 illustrates an exploded view of the program organizing system 112 of FIG. 1 according to an embodiment herein. The program organizing system 112 includes a database 202, an organizing module 204, an updating module 206, and a display module 208. The database 202 stores the list of television programs and corresponding broadcast timings, an EPG, or an online television program guide information, and information relating to user's interests. The organizing module 204 further includes a categorizing module 204A and a prioritizing module 204B. The organizing module 204 organizes the list of television programs that may be of the user's interest based on the airing time of the programs. In one embodiment, a television program schedules for one or more channels are obtained. For example, the television program schedules include a television programs that correspond to different time slots for each of the one or more channels. In one embodiment, the organizing module may include filtering module to obtain a list of filtered television programs based on a set of parameters.

In one embodiment, the categorizing module 204A may categorizes the list of filtered television programs according to the broadcast time to obtain a list of organized television programs (e.g., now, today and this week or later) to be watched by the user 116. In one embodiment, the method of organizing the electronic program guide (EPG) data into now, next and later may use a set of parameters (e.g., one or more parameters) of recommended television shows based on the user habits or interests. For example, “show only sports television shows” or “show top relevant television shows for the user” or “show only popular television shows in the next one week”, etc. The prioritizing module 204B prioritizes the list of organized television programs based on the user's interest, a user's relevancy, which is likely to be watched for the entire week.

In one embodiment, an organized television programs are prioritized (e.g., personalized to a user) and displayed to the user 116 based on the one or more parameters. For example, the list of organized television programs that are personalized which includes at least one of (i) a first personalized list of television programs that are scheduled to be broadcasted at a current time, and (ii) a second personalized list of television programs. In another embodiment, at least a subset of a television programs that are scheduled at a current time (e.g., which are independent of channel) are personalized to obtain the first personalized list of television programs. Similarly, at least a subset of a television programs (e.g., which are independent of channel) includes television programs that are scheduled at a subsequent duration to obtain a second personalized list of television programs.

For example, the one or more parameters may be at least one of (a) popularity ratings, (b) gathering information from a social network (e.g., television programs liked or reviewed by other users, activities of at least one user connected to the user on a social medium (c) interests or online viewing habits associated with user's, and (d) gathering information from an electronic program guide (EPG)). In one embodiment, the one or more parameters does not include channel (e.g., a channel identifier such as channel number) associated with the television programs.

The updating module 206 updates the list of organized television programs which are to be watched in the database 202 at regular intervals. In one embodiment, the first personalized list of television programs and the second personalized list of television programs to be displayed may be dynamically updated based on (i) the current time, and (ii) the one or more parameters. The display module 208 displays the list of television programs in such a way that programs to be aired now, next and later are displayed in the display device 108.

In one embodiment, a first combination of channels and a second combination of channels is selected and ordered based on the one or more parameters which are targeted to a user. For example, the first combination of channels and the second combination of channels are different. In one embodiment, an indication to navigate from a first subset of television programs to a second subset of television programs, whereas the first subset of television programs and the second subset of television programs are selected from at least one of (a) the first personalized list of television programs that are scheduled for broadcast across the first combination of channels at the current time, and (b) the second personalized list of television programs that are scheduled to be broadcast across the second combination of channels in the subsequent duration based on broadcast information.

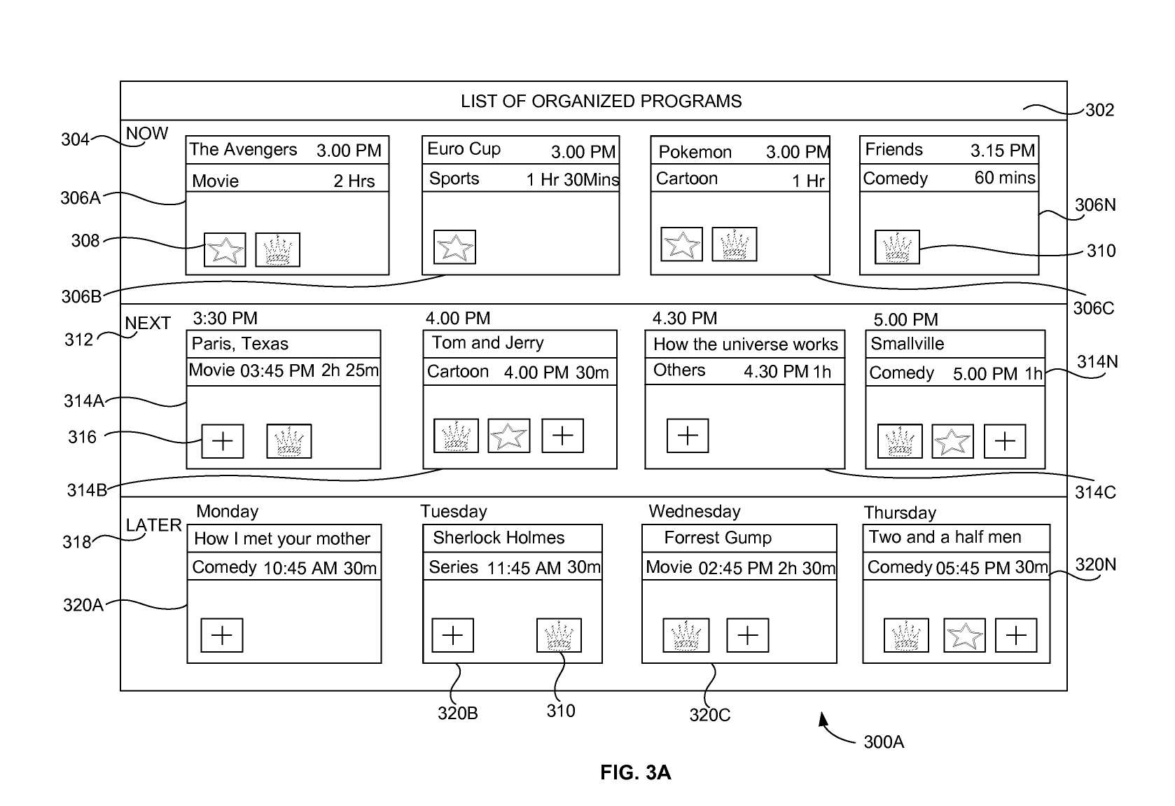

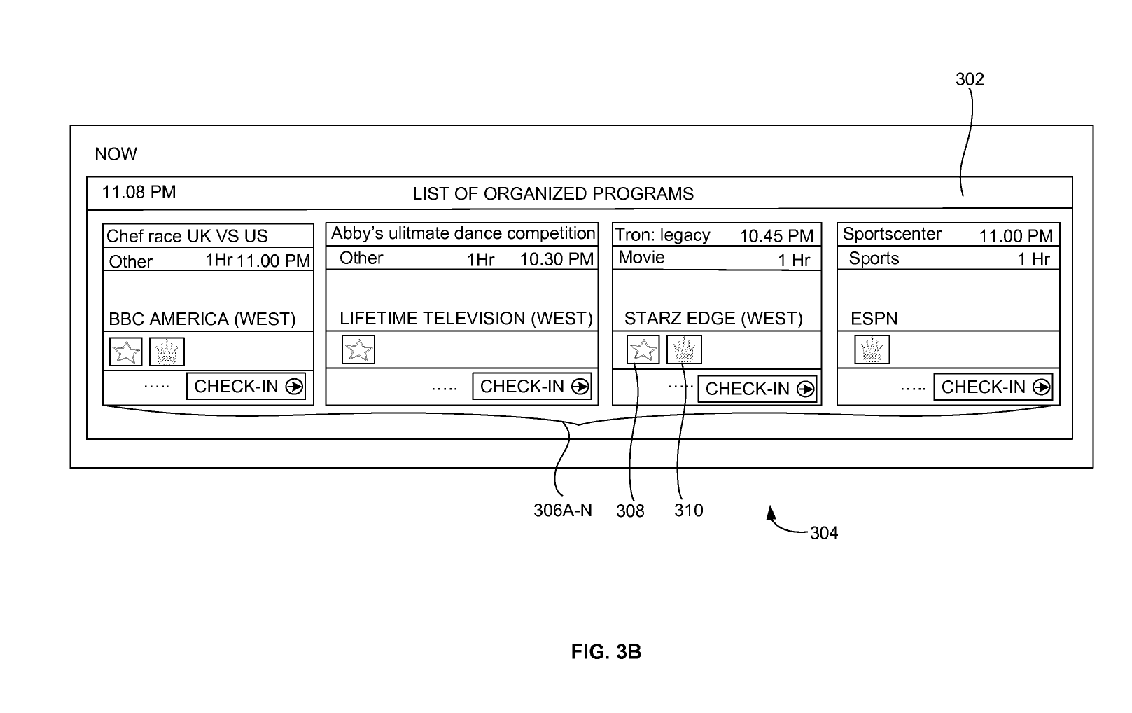

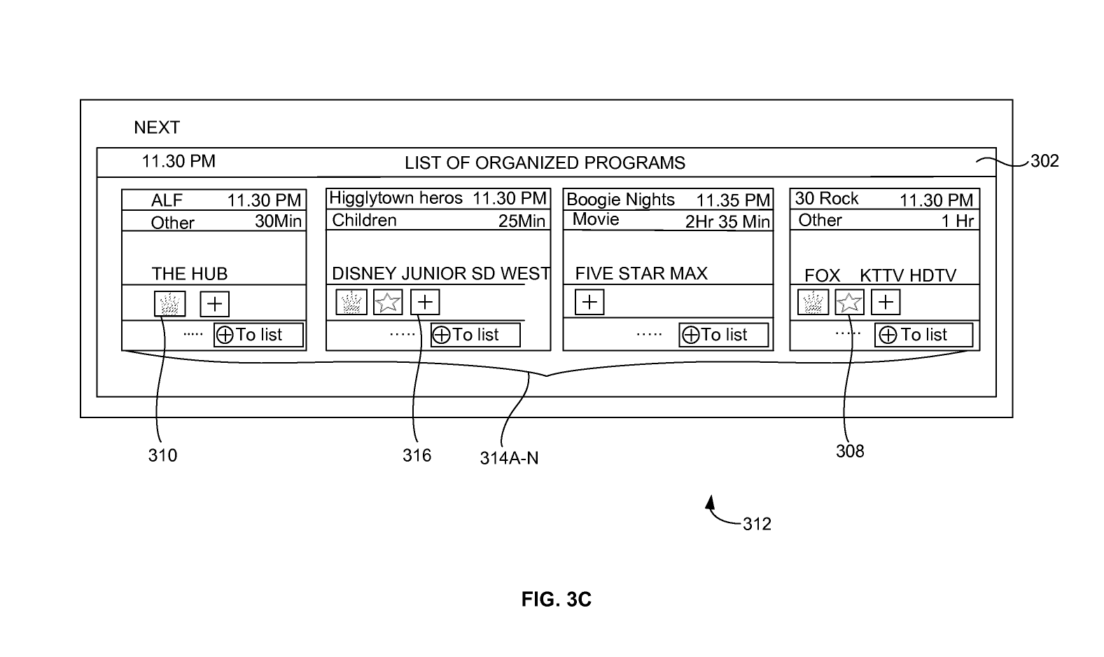

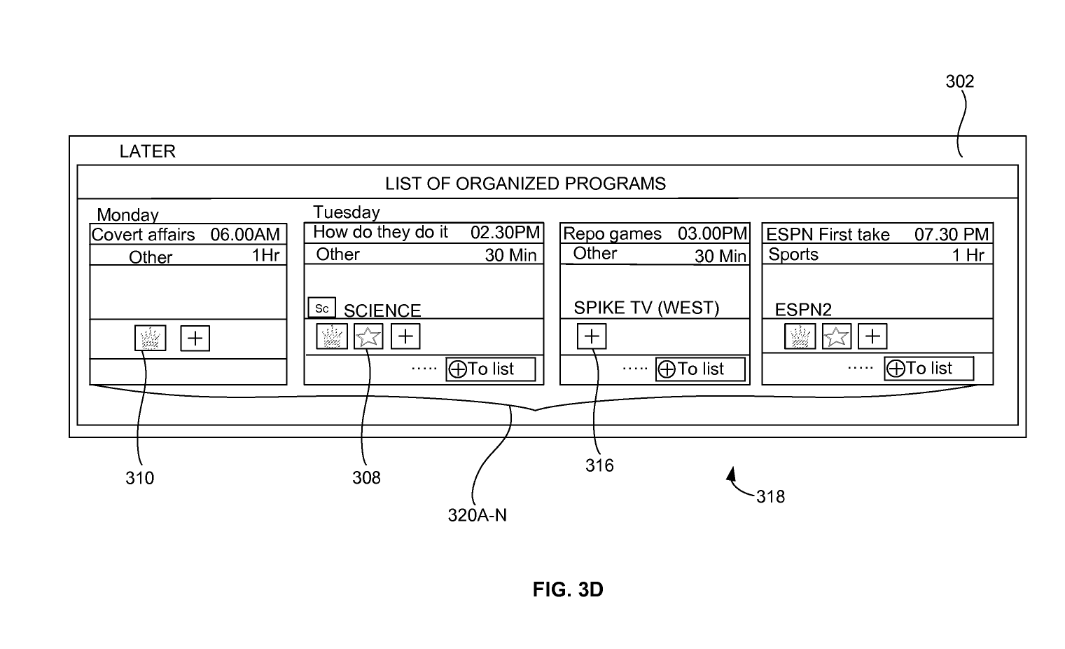

FIG. 3A illustrates a user interface view 300 of how the list of television programs is organized and displayed according to an embodiment herein. A list of organized programs field 302 includes a list of television programs 306A-N that are aired now, a list of television programs 314A-N that are to be aired next on the same day, and a list of television programs 320A-N to be aired later this week. In one embodiment, the list of organized programs field 302 displays the list of television programs into now, next and later which are to be aired based on time bound live electronic program guide (EPG) data. The “Now” field 304 displays the list of television programs 306A-N that are currently aired. For example television movie “The Avengers” which is to be broadcasted now i.e. at 3.00 PM and another show “Friends” which is to be broadcasted now i.e. at 3.15 PM at the display device 108.

The “Next” field 312 displays the list of television programs 314A-N that are relevant to be aired on the same day, further broken down into an hourly basis. In one embodiment, the television comedy e.g. “Small vile” and “Paris, Tex.” movie and cartoon shows “Tom and jerry” are displayed to the display device 108. The “Later” field 308 displays the list of television programs 320A-N that will be aired on different days of that particular week or subsequent weeks. For example comedy series “Two and a half men” and “Forrest Gump” movie which are all being aired on different days of that particular week. In one embodiment, a list of organized television programs that are of interest to the user 116, which are scheduled to be aired later this week is displayed in the display device 108.

Each of the list of television programs may include a favorites field 308, a popular field 310 and an add to watch list field 316. The add to watch list field 316 enables the user 116 to create activities by adding to his/her watch list, television programs that are going to aired in the future. When the user 116 has added a television program to his/her watch list, the program organizing system 112 may subsequently alert the user 116 via a notification message (e.g. an alert, a reminder) indicating that the particular program is currently aired when it is aired. The favorites field 308 allows the user 116 to mark one or more television programs as his/her favorite television programs.

With reference to FIG. 3A, FIG. 3B illustrates a user interface view of organizing and displaying the list of television programs that are currently broadcasted according to an embodiment herein. The list of organized programs field 302 displays the list of television programs 306A-N that are currently aired. Upon receiving an input e.g. click on “Now” field 304, one or more television programs that are currently aired are displayed. For example “Chef Race UK vs. US” show, “Abby's ultimate dance competition” show, “Tron legacy” movie and “Sportscenter” are displayed as television programs that are currently aired when the user 116 clicks on the “Now” field 304. In one embodiment, a selection of a television program from the first personalized list of television programs which includes a plurality of subset of programs. The content associated with the television program that is selected from the first personalized list of television programs is displayed. Similarly, a selection of a television program from the second personalized list of television programs, and generating at least one of (i) a watch list, and (ii) a favorites list that includes the television program which is selected from the second personalized list of television programs. In one embodiment, similarity between a watch list of a first user and a watch list of a second user is computed. Automatically recommending (i) a first list of non-overlapping television program to the first user based on the watch list of the second user and the similarity, and (ii) a second list of non-overlapping television program to the second user based on the watch list of the first user and the similarity. For example, User A and User B “watchlist”ed many programs which indicates that high similarity between User A and User B, then the program organizing system 112 recommend other non-overlapping programs to each other. In one embodiment, users are allowed to do activities such as watchlist on the programs/shows which are going to be aired in the future. For example, User A “watchlist”ed a program P that are to be broadcasted four days later, then friends of user A may be recommended with program P in the “later” recommendations.

With reference to FIG. 3A, FIG. 3C illustrates a user interface view of organizing and displaying the list of television programs that are scheduled to be broadcasted at a subsequent duration according to an embodiment herein. The list of organized programs field 302 displays the list of television programs 314A-N that are to be aired next on the same day. Upon receiving an input e.g. by clicking on the “Next” field 312, one or more television programs that are to be aired next on that day are displayed. For example “ALF” show, “Higgleytown heros” show for children, “Boogie nights” movie and a “30 Rock” show are displayed as television programs that are to be aired next on that day when the user 116 clicks on the “Next” field 312.

With reference to FIG. 3A, FIG. 3D illustrates a user interface view of organizing and displaying the list of television programs that are scheduled to be broadcast at the subsequent duration according to an embodiment herein. The list of organized programs field 302 displays the list of television programs 320A-N that are to be aired next on that day. Upon receiving an input e.g. click on “Later” field 318 one or more television programs that will be aired on different days of that particular week or subsequent weeks are displayed. For example “Covert affairs” show, “How do they do it” show, “Repo games” show and “ESPN first take” sports show are displayed as television programs that will be aired on different days of that particular week or subsequent weeks when the user 116 clicks on the “Later” field 318.

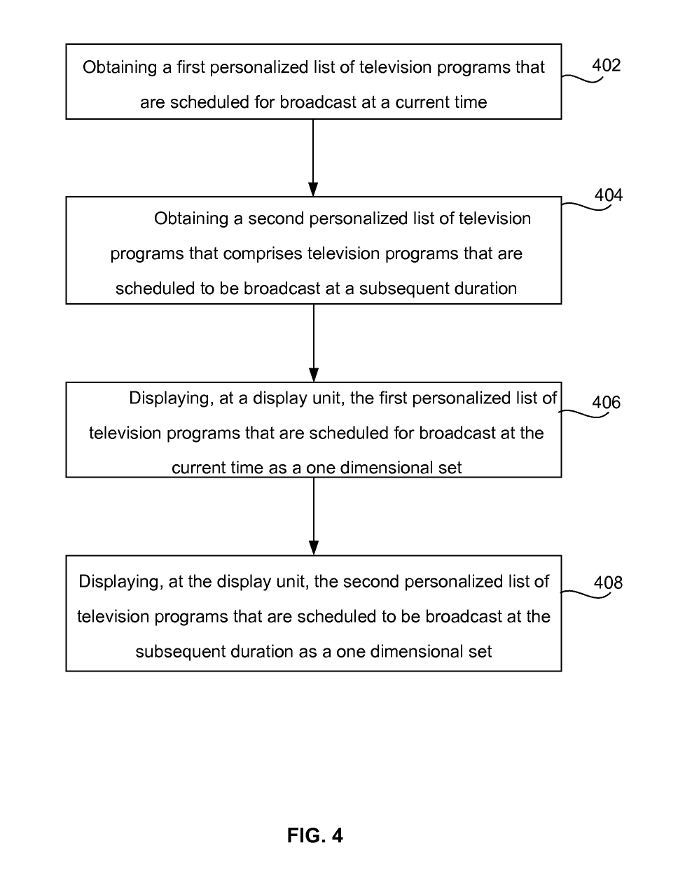

FIG. 4 is a flow diagram illustrating a method of organizing and displaying a list of television programs that are targeted to the user according to an embodiment herein. In step 402, a first personalized list of television programs that are scheduled for broadcast at a current time are obtained. In step 404, a second personalized list of television programs that comprises television programs that are scheduled to be broadcast at a subsequent duration are obtained. In step 406, the first personalized list of television programs that are scheduled for broadcast at the current time as a one dimensional set is displayed at a display unit. In step 408, the second personalized list of television programs that are scheduled to be broadcast at the subsequent duration as a one dimensional set is displayed at the display unit.

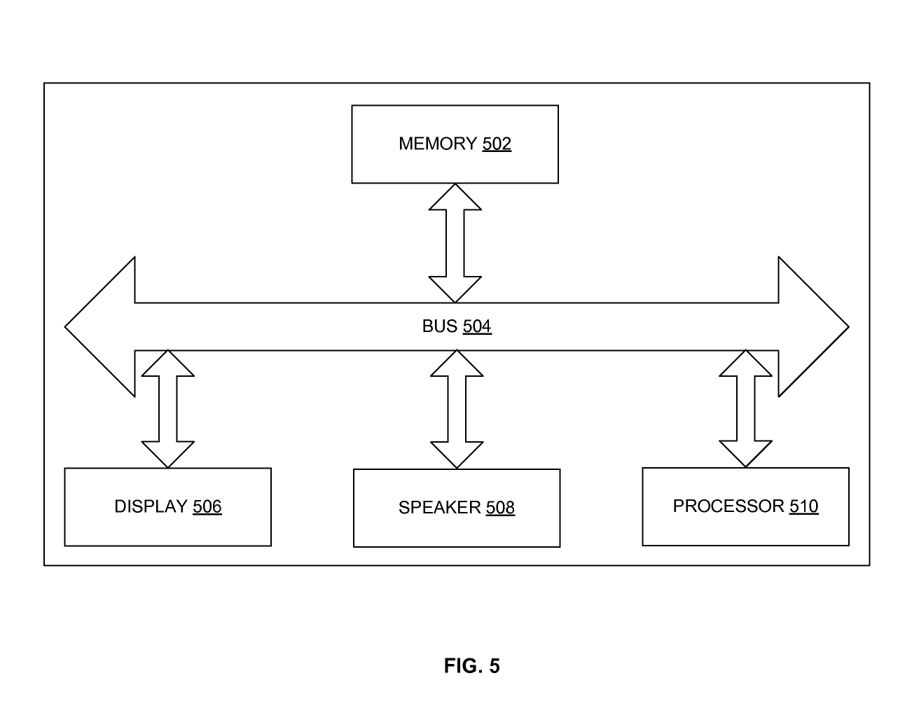

FIG. 5 illustrates an exploded view of the computing device 114 of FIG. 1 having an a memory 502 having a set of computer instructions, a bus 504, a display 506, a speaker 508, and a processor 510 capable of processing a set of instructions to perform any one or more of the methodologies herein, according to an embodiment herein. In one embodiment, the receiver may be the computing device 114, the set-top box 106, and the display device 108. The processor 510 may also enable digital content to be consumed in the form of video for output via one or more displays 506 or audio for output via speaker and/or earphones 508. The processor 510 may also carry out the methods described herein and in accordance with the embodiments herein.

Digital content may also be stored in the memory 502 for future processing or consumption. The memory 502 may also store program specific information and/or service information (PSI/SI), including information about digital content (e.g., the detected information bits) available in the future or stored from the past. A user of the receiver may view this stored information on display 506 and select an item of for viewing, listening, or other uses via input, which may take the form of keypad, scroll, or other input device(s) or combinations thereof. When digital content is selected, the processor 510 may pass information. The content and PSI/SI may be passed among functions within the receiver using the bus 504.

The techniques provided by the embodiments herein may be implemented on an integrated circuit chip (not shown). The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly.

The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The embodiments herein can take the form of, an entirely hardware embodiment, an entirely software embodiment or an embodiment including both hardware and software elements. The embodiments that are implemented in software include but are not limited to, firmware, resident software, microcode, etc. Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, remote controls, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

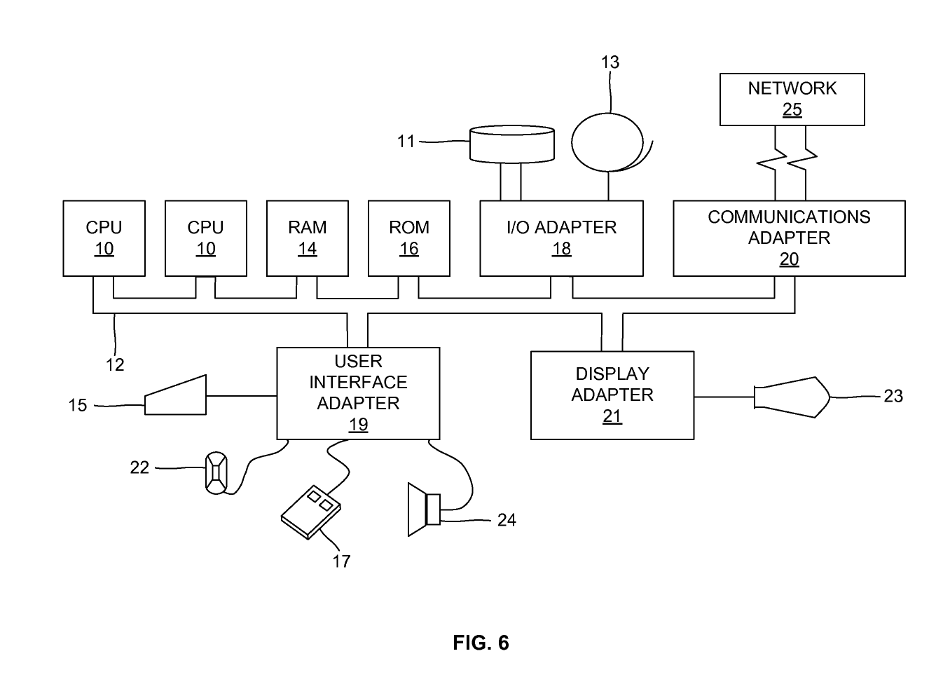

A representative hardware environment for practicing the embodiments herein is depicted in FIG. 6. This schematic drawing illustrates a hardware configuration of an information handling/computer system in accordance with the embodiments herein. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein.

The system further includes a user interface adapter 19 that connects a keyboard 15, mouse 17, speaker 24, microphone 22, and/or other user interface devices such as a touch screen device (not shown) or a remote control to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The program organizing system 112 organizes the list of television programs to be aired into now, later today, and this week and present in a one dimensional format. The program organizing system 112 also enables collecting the future trends of the television programs and enhances the ability to gauge the future trends of the television programs. This enables the user 116 to schedule one or more future programs in advance. The program organizing system 112 helps in re-imagining static electronic program guide (EPG) data into personalized dynamic content. The program organizing system 112 helps users to do activities such as watchlist on the television programs/shows which are going to be aired in the future. This enables to infer relative popularity of particular show/program compared to other shows which are going to be aired in future. These forward looking trends may be used in serving better recommendations significantly to the users. The program organizing system 112 enables an effective television programs recommendations with activities of friends are received positively. This organization of the list of television programs helps the user 116 in discovering and navigating the television programs quickly and easily, by cutting across channels when compared to the traditional EPG presentation, where users have to navigate the program guide in two dimensions—channels and time, to know the television programs being aired and the television programs to be aired.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within their spirit and scope of the appended claims.

What is claimed is:

1. A method for organizing a plurality of television programs, said method comprising:
(i) obtaining a first personalized list of television programs that are scheduled for broadcast at a current time;
(ii) obtaining a second personalized list of television programs that comprises television programs that are scheduled to be broadcast at a subsequent duration, wherein said first personalized list of television programs and said second personalized list of television programs are personalized separately based on at least one parameter other than a channel associated with said television programs;
(iii) displaying, at a display unit, said first personalized list of television programs that are scheduled for broadcast at said current time as a one dimensional set; and
(iv) displaying, at said display unit, said second personalized list of television programs that are scheduled to be broadcast at said subsequent duration as a one dimensional set.

2. The method of claim 1, further comprising, dynamically updating said first personalized list of television programs and said second personalized list of television programs to be displayed based on (i) said current time, and (ii) a set of parameters.

3. The method of claim 1, wherein a first combination of channels and a second combination of channels is selected and ordered based on said set of parameters which are targeted to a user, wherein said first combination of channels and said second combination of channels are different.

4. The method of claim 1, further comprising processing, by a processor, filtering said plurality of television program to obtain a list of filtered television programs based on said set of parameters, wherein said set of parameters comprises at least one of a) interests or habits associated with a user, b) preferences of said user from a viewing pattern of said user, (c) activities of at least one user connected to said user on a social medium, (d) online viewing habits of said user, and (e) popularity ratings.

5. The method of claim 1, wherein said list of filtered television programs is organized to obtain at least one of (a) said first personalized list of television programs that are scheduled for broadcast across said first combination of channels at said current time, and (b) said second personalized list of television programs that are scheduled to be broadcast across said second combination of channels in said subsequent duration based on broadcast information, wherein said broadcast information comprises a broadcast time associated with said list of filtered television programs.

6. The method of claim 1, wherein said subsequent duration is a remaining part of a same day as said current time.

7. The method of claim 1, wherein said subsequent duration ranges from a next day to a remaining part of a same week as said current time.

8. The method of claim 1, wherein said subsequent duration is a range of time slots associated with television program schedule in a one dimensional set.

9. The method of claim 5, further comprising processing, by said processor, a first input comprising at least one of:
(a) a selection of a television program from said first personalized list of television programs, wherein said first personalized list of television programs comprises a plurality of subset of programs, or
(b) a selection of a television program from said second personalized list of television programs.

10. The method of claim 9, further comprising processing, by said processor,
(a) displaying, at said display unit, content associated with said television program that is selected from said first personalized list of television programs, or (b) generating at least one of (i) a watch list, and (ii) a favorites list that comprises said television program which is selected from said second personalized list of television programs.

11. The method of claim 10, further comprising, (a) computing a similarity between a watch list of a first user and a watch list of a second user, and (b) recommending (i) a first list of non-overlapping television program to said first user based on said watch list of said second user and said similarity, and (ii) a second list of non-overlapping television program to said second user based on said watch list of said first user and said similarity.

12. The method of claim 10, further comprising processing, by said processor, a second input comprising an indication to navigate from a first subset of television programs to a second subset of television programs, wherein said first subset of television programs and the second subset of television programs are selected from at least one of (a) said first personalized list of television programs, and (b) said second personalized list of television programs.

13. A system for organizing television programs, said system comprising:
a processor; and
a memory storing instructions to configure said processor, wherein said processor is configured by said instructions to:
(a) obtain a plurality of television programs;
(b) filter said plurality of television programs to obtain a list of filtered television programs based on a set of parameters;
(c) obtain broadcast information associated with said list of filtered television programs from an electronic program guide server, wherein said broadcast information comprises a broadcast time associated with said television program;
(d) organize said list of filtered television programs to obtain a list of organized television programs based on said broadcast information, wherein said list of organized television programs comprises (i) a first personalized list of television programs that are scheduled for broadcast across a first combination of channels at a current time, and (i) a second personalized list of television programs that are scheduled to be broadcast across a second combination of channels in a subsequent duration, wherein said first combination of channels and said second combination of channels are different, wherein said first combination of channels and said second combination of channels is selected and ordered based on a set of parameters which are targeted to a user, and
(d) communicate said list of organized television programs to a display module, executed by said processor, to display at said display unit, (i) said first personalized list of television programs that are scheduled for broadcast across said first combination of channels at said current time, and (i) said second personalized list of television programs that are scheduled to be broadcast across said second combination of channels in said subsequent duration.

14. The system of claim 13, wherein said subsequent duration is a remaining part of a same day as said current time.

15. The system of claim 13, wherein said subsequent duration ranges from a next day to a remaining part of a same week as said current time.

16. The system of claim 13, wherein said subsequent duration is a range of time slots associated with television program schedule in a one dimensional set.

17. The system of claim 13, wherein said processor is further configured to process a first input comprising at least one of (i) a selection of a television program from said first personalized list of television programs, wherein said first personalized list of television programs comprises a plurality of subset of programs, or (ii) a selection of a television program from said second personalized list of television programs.

18. The system of claim 17, wherein said processor is further configured to (a) display, at said display unit, content associated with said television program that is selected from said first personalized list of television programs, or (b) generate at least one of (i) a watch list, and (ii) a favorites list that comprises said television program which is selected from said second personalized list of television programs.

19. The system of claim 13, further comprises a navigation module, executed by said processor, that process a second input comprising an indication to navigate from a first subset of television programs to a second subset of television programs, wherein said first subset of television programs and said second subset of television programs are selected from (a) said first personalized list of television programs, and (b) said second personalized list of television programs.

20. The system of claim 13, wherein said set of parameters comprises at least one of a) interests or habits associated with a user, b) preferences of said user from a viewing pattern of said user, (c) activities of at least one user connected to said user on a social medium, (d) online viewing habits of said user, and (e) popularity ratings.

21. A program organizing server for organizing television programs that is targeted to a user, said program organizing server comprising:
a processor; and
a memory storing instructions to configure said processor, wherein said processor is configured by said instructions to
obtain television program schedules for one or more channels, wherein said schedules comprise television programs that correspond to different time slots for each of said one or more channels;
personalize, independent of channel, at least a subset of said television programs that are scheduled at a current time to obtain a first personalized list of television programs;
personalize, independent of channel, at least a subset of said television programs that comprises television programs that are scheduled at a subsequent duration to obtain a second personalized list of television programs;
display, at a display unit or communicate to a display unit, said first set of personalized television programs in a one dimensional format of personalized television programs; and
display, at a display unit, or communicate to a display unit said second set of personalized television programs in a one dimensional format of personalized television programs.

22. A method for organizing a plurality of television program, said method comprising:
(i) obtaining at least one of (a) a first personalized list of television programs, and (b) a second list of personalized television programs; and
(ii) displaying, at a display unit, (a) said first personalized list of television programs that are scheduled for broadcast across a first combination of channels at a current time, and (b) said second personalized list of television programs that are scheduled to be broadcast across a second combination of channels in a subsequent duration, wherein said first combination of channels and said second combination of channels are different, wherein said first combination of channels and said second combination of channels is selected and ordered based on a set of parameters which are targeted to a user.
